(19) United States
(12) Patent Application Publication
(10) Pub. No.: US 2005/0029404 A1
(43) Pub. Date: Feb. 10, 2005

(54) Arrangement for fixing an insulating blanket and related method

(76) Inventors: Jean-Paul Rene Andre Hogie, Le Havre (FR); Patrice Denis Loisel, Bolbec (FR); Jean-Claude Eugene Henri Mahieu, Le Havre (FR)

Correspondence Address: OLIFF & BERRIDGE, PLC, P.O. BOX 19928, ALEXANDRIA, VA, 22320, US

(21) Appl. No.: 10/489,678

(22) PCT Filed: Sep. 18, 2002
(86) PCT No.: PCT/FR02/03184

(30) Foreign Application Priority Data
Sep. 20, 2001 (FR) 0112132

(51) Int. Cl. B64G 1/50

(52) U.S. Cl. 244/158 A

(57) ABSTRACT

System for fixing an insulation blanket (2) to a panel (1). It comprises buttons (8), loops (9) with ends twisted together, and hooks (12) that can easily accommodate the loops (9) when the blanket (2) is already laid.

This text deals with a system for fixing an insulation blanket to an aircraft panel, and an associated method.

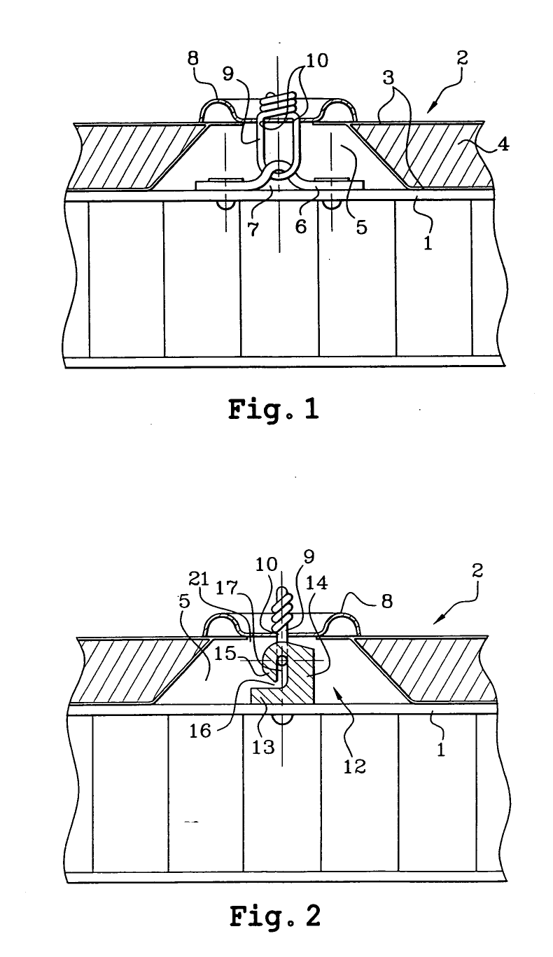

Some aircraft panels are covered with a heat insulation blanket to block the radiation from a neighboring heat source. Other insulation properties, notably acoustic, may also be desired. These blankets usually contain fibers or other insulating wadding material between two metal sheets. They are usually attached by points to the panel by the system shown in FIG. 1, where the panel bears the reference 1, the blanket the reference 2, the sheets the reference 3 and the wadding the reference 4. The blanket 2 contains openings 5 leading to the panel 1 and exposing staples 6 riveted to the panel 1 which consist of plates bent in the center to form an eyelet 7.

Buttons 8 are placed on the blanket 2 over the openings 5, and a loop of wire 9 is engaged in the eyelet 7 and through two holes 10 in the button 8 so that it ends appear on the surface of the blanket 2 where they are then twisted together to close the loop 9. It then becomes impossible to pull the button 8 off, and the blanket 2 stays in place on the panel 1.

It is not easy to manipulate the loops 9 inside the openings 5 if the openings are narrow and deep, and it is especially difficult to engage them in the eyelets 7. It is for this reason that it is usual to begin with the loops 9 and introduce them through the eyelets 7, before putting the blanket 2 in position and finally fitting the buttons 8 by inserting the ends of the loop 9 through the holes 10 before closing the loop 9. But this method is still difficult and slow, and necessitates the use of relatively long loops 9; in order to allow the loops 9 and staples 6 to be assembled together through the openings 5, the blanket surfaces must be small; and it is often impossible to repair a defective fixing point, with the blanket 2, if a new loop 9 cannot be inserted into the eyelet 7.

The subject of the invention is a system for fixing a heat insulation blanket to an aircraft panel that is to be protected, comprising: an opening passing through the blanket and ending in an eyelet; a button pierced by two holes and covering the opening; and a loop of wire passing through the holes, assembled onto the button and inserted underneath the button; which system is characterized in that it comprises a hook which is fixed to the panel by a base, rises into the opening of the blanket toward the button, and then bends back toward the panel, ending in a free end at a distance toward the panel and from the base, and in that the loop occupies the curved end of the hook fixed to the panel, forming a housing. This system is much easier to assemble than the previous system and is not difficult to repair after the blanket has been installed.

The following figures serve as a foundation for the detailed description of the invention and will assist in understanding its various aspects:

FIG. 1, already described, is a view of a system for fixing an insulation blanket to a panel in accordance with the prior art,

FIG. 2 is a view of the invention, and

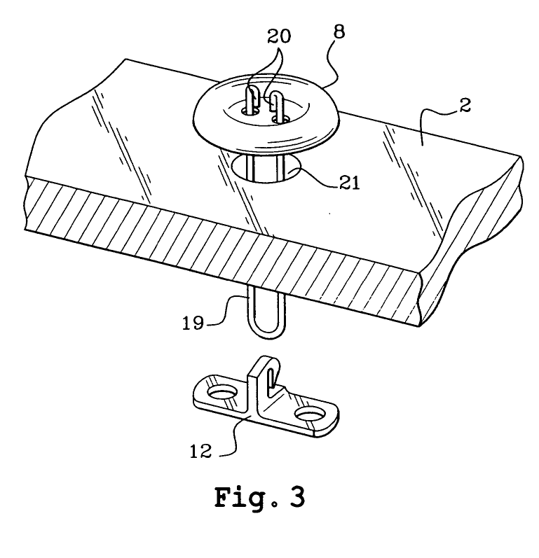

FIG. 3 illustrates an alternative method of assembly permitted by the invention.

Referring to FIG. 2, it can be seen that the staple 6 has been replaced by a hook 12 comprising a base 13 riveted to the panel 1, with a main portion 14 extending up into the opening 5 above the panel 1 and an end portion 15 which is bent back down toward the base 13, from which it is separated by a gap 16 leading to a housing 17 underneath the hook. The loop 9 is engaged here in the housing 17. As before, it is engaged through a pair of holes 10 in the button 8 (only one hole is shown here) and its ends are twisted together on top of the button 8 to close the loop.

The value of the invention will become clearer in the course of the commentaries on the method of assembly. In contrast to current practice, it becomes possible to start by placing the blanket 2 on the panel 1, with the hooks 12 in the openings 5, and then lower the loops 9 through the eyelets 21 into the openings 5, as it is sufficient to move them sideways in order to get them into the housings 17 via the gaps 16, without having to deform or turn them, whereas this was necessary previously in order to lower one end of the loop 9 into the staple 6 before it could be threaded back up through the blanket 2 in the restricted space of the openings 5. The button 8 can be lowered onto the openings 5 when the loops 9 have been installed in the hooks 12, and, as before, the ends of the loop are inserted through the holes 10 and joined together to close the loop 9.

As will be appreciated, this fixing system lends itself easily to repair by replacing the damaged loop 9 with another loop. Also, in a variant of the method illustrated in FIG. 3, the loop 9 can be replaced with a loop in the form of a preformed pin 19 whose ends 20 are bent over so as to rest on the buttons 8 by the side of the holes 10. Acting together as a unit, the buttons 8 and pin loops 19 are lowered into the respective openings 5, the loops 19 passing through the eyelets 21 of the blanket 2, through which the openings 5 communicate with the exterior, and then moved sideways to feed the pin loops 19 through the gaps 16. The pin loops 19 can then be drawn back up into the housings 17 and the ends 20 joined together.

1. A system for fixing an insulation blanket (2) to an aircraft panel (1) that is to be protected, comprising: an opening (5) passing through the blanket and ending in an eyelet (21); a button (8) pierced by two holes (10) and covering the opening; and a loop (9) of wire passing through the holes, assembled onto the button (8) and inserted underneath the button; which system is characterized in that it comprises a hook (12) which is fixed to the panel by a base (13), rises into the opening (5) of the blanket toward the button (8), and then bends back toward the panel, ending in a free end at a distance from the panel and from the base so as to form a housing (17), and in that the loop (9) occupies the housing.

2. A method of fixing an insulation blanket (2) to an aircraft panel (1) that is to be protected, characterized in that it consists in first placing the blanket (2) on the panel (1), such that openings (5) passing through the blanket and ending in eyelets (21) are placed in front of the hooks (12) mounted on the panel; engaging loops (9) of wire in the hooks; lowering buttons (8) onto the eyelets in such a way that the ends of the loops (9) pass through two holes (10) in the buttons; and joining the ends of the loops to close the loops.

3. A method of fixing an insulation blanket to an aircraft panel that is to be protected, characterized in that it consists in first placing the blanket (2) on the panel (1), such that openings (5) passing through the blanket and ending in eyelets (21) are placed in front of the hooks (12) mounted on the panel; lowering buttons (8) toward the eyelets, the buttons having loops (19) of wire that have two ends that pass through the buttons via two holes (10) and that are deformed so as to press down on the button; moving the buttons (8) about on the blanket (2) to engage the loops (19) in the hooks (12); and joining the ends of the loops to close the loops.
